(19) United States
(12) Patent Application Publication
(10) Pub. No.: US 2013/0214874 A1
(43) Pub. Date: Aug. 22, 2013

(54) LOW NOISE BLOCK DOWNCONVERTER WITH HIGH ISOLATION

(71) Applicants: WEN-CHAO SHEN, TAOYUAN COUNTY (TW); WEN-YEN SHEN, TAOYUAN COUNTY (TW); CHENG-NIEN SU, TAOYUAN COUNTY (TW)

(72) Inventors: WEN-CHAO SHEN, TAOYUAN COUNTY (TW); WEN-YEN SHEN, TAOYUAN COUNTY (TW); CHENG-NIEN SU, TAOYUAN COUNTY (TW)

(73) Assignee: AZURE SHINE INTERNATIONAL, INC., TAOYUAN COUNTY (TW)

(21) Appl. No.: 13/424,631

(22) Filed: Mar. 20, 2012

(30) Foreign Application Priority Data
Feb. 20, 2012 (TW) 101105397

(51) Int. Cl. H01P 5/12

(52) U.S. Cl. 333/137; 333/248; 333/21 A

(57) ABSTRACT

A Low Noise Block downconverter (LNB) with high isolation, and more particularly, to a low-noise-block downconverter design for horizontal wave and vertical wave of a linear polarization; wherein, a horizontal probe and a vertical probe are directly set on a printed circuit board to receive the aforesaid waves; a waveguide chamber of the horizontal probe is divided into two chambers, a front chamber and a back chamber; a waveguide chamber of the vertical probe is transversely extended from a side waveguide, and the waveguide chamber of the vertical probe is also divided into two chambers; thereby the horizontal and vertical probe respectively receives the waves when facing to the rear side of the waveguide chambers for separating the horizontal and vertical wave and reducing the coupling of each other; thus, increasing the isolation and preventing the mutual interference of the horizontal and vertical wave.

### BACKGROUND OF THE INVENTION

1. Field of the Invention

The present invention relates to a Low Noise Block downconverter (LNB) and more particularly, to a Low Noise Block downconverter (LNB) with high isolation, which reduces the mutual interference of the horizontal and vertical wave being fed in the waveguide.

2. Description of the Related Art

A Low Noise Block downconverter (LNB) includes a feedhorn, a waveguide, and probes installed in a waveguide in order to receive a high-frequency satellite signal from a dish antenna, amplify the high-frequency satellite signal, converter it to a medium-frequency signal, and finally send it to an output terminal.

Generally, a satellite signal uses a vertical wave and a horizontal wave of a linear polarization for transmitting. Therefore, while simultaneously receiving two kinds of the waves, a satellite downconverter must highly isolate the linear polarized signal to avoid the mutual interference in the waveguide.

The following illustrations are aimed at increasing the isolation and reducing the mutual interference of the horizontal and vertical wave.

At present, a Low Noise Block downconverter (LNB) 10 as shown in FIG. 1 is composed of a waveguide 11, a printed circuit board 12, a horizontal polarized probe 13, a vertical polarized probe 14 and an output terminal 15. The conventional Low Noise Block downconverter (LNB) 10 has following drawbacks:

1. When assembling the Low Noise Block downconverter (LNB) 10, the horizontal (Y-axis) polarized probe 13 and the vertical (Z-axis) polarized probe 14 must be separately set in the waveguide 11 in sequence to form in a phase difference of 90° angle, resulting not only in a complicated assembly operation, but also in a positioning error between the horizontal polarized probe 13 and the vertical polarized probe 14, which leads to a poor reception of signals.

2. It is easy for horizontal polarized signals to be coupled with the vertical polarized signals because both of the horizontal polarized probe and the vertical polarized probe are installed in the same waveguide. This kind of design easily results in a poor isolation and a mutual interference of the signals.

3. Therefore, there are plenty of researchers have been devoting to developing a better design of a Low Noise Block downconverter to overcome the above-mentioned drawbacks. Such disclosures include U.S. Pat. Nos. 5,459,441, 5,245,353, 2,825,060, 4,356,459, 6,980,065, 6,211,750, 5,438,340, etc. The working principle of above mentioned patents is to set the probes into the waveguide and be connected to a Low Noise Amplifier (LNA). However, there are two points of this probe design to be considered; first, whether the isolation of a horizontal wave and a vertical wave is increased; second, whether the probes are easy to be produced and assembled.

The first point is about an electric characteristic standard requirement of the probes, and the second point is about taking into account whether it is conducive to the production. Base on the features of the conventional probe design disclosed, some can improve the electric characteristic standard but cannot be conductive to an easy production and assembly; some can be conductive to an easy production and assembly but cannot provide a desirable electric characteristic standard.

4. At present, there is a probe design providing a horizontal probe and a vertical probe being directly set on a printed circuit board, such as U.S. Pat. No. 5,995,818. This kind of probe design has advantages of easy production, easy assembly and low cost; however, the probes are also arranged in the waveguide 11 as shown in FIG. 1, resulting a signal coupling and poor isolation. Therefore, there is room for improvement.

### SUMMARY OF THE INVENTION

It is a primary object of the present invention to provide a Low Noise Block downconverter (LNB) with high isolation, which improves the isolation of a horizontal wave and a vertical wave to overcome the conventional probes having a poor isolation.

The second object of the present invention to provide a Low Noise Block downconverter (LNB) with high isolation, which enables the probes to be in an accurate position and to be easily produced and assembled.

In order to achieve the above-mentioned objects, the invention includes: a body having a recessed accommodation area inside thereof; a printed circuit board being arranged in the recessed accommodation area and being electronically connected to an output terminal; a waveguide being a tubular body extending forward from the body to form a first waveguide chamber in the waveguide; and a feedhorn being composed of a serial concentric ring on a front end of the waveguide;

wherein the body is composed of a front cover and a rear cover, a forward extended third waveguide chamber being connected with a side of the first waveguide chamber of the waveguide, the rear cover corresponding to the third waveguide chamber has a backward extended fourth waveguide chamber, the rear cover corresponding to the first waveguide chamber has a backward extended second waveguide chamber; and a rear side of the printed circuit board corresponding to the second waveguide chamber and the fourth waveguide chamber has a horizontal probe and a vertical probe being directly set on the surface thereof;

whereby the horizontal probe is located between the first waveguide chamber and the second waveguide chamber and facing to the second waveguide chamber for receiving horizontal polarized wave, and the vertical probe is located between the third waveguide chamber and the fourth waveguide chamber and facing to the fourth waveguide chamber for receiving vertical polarized wave; thus, a signal of the horizontal wave and a signal of the vertical wave can be separated by the first, second, third, and fourth waveguide chambers.

Based on the technical features disclosed, the present invention not only overcomes the problem of conventional probes which is not easy to assemble and manufacture but improves the poor isolation caused by the signal coupling of the probes. The present invention achieves both easy assembly for saving costs and high signal isolation effects.

### BRIEF DESCRIPTION OF THE DRAWINGS

FIG. 1 is a schematic diagram of a conventional downconverter;

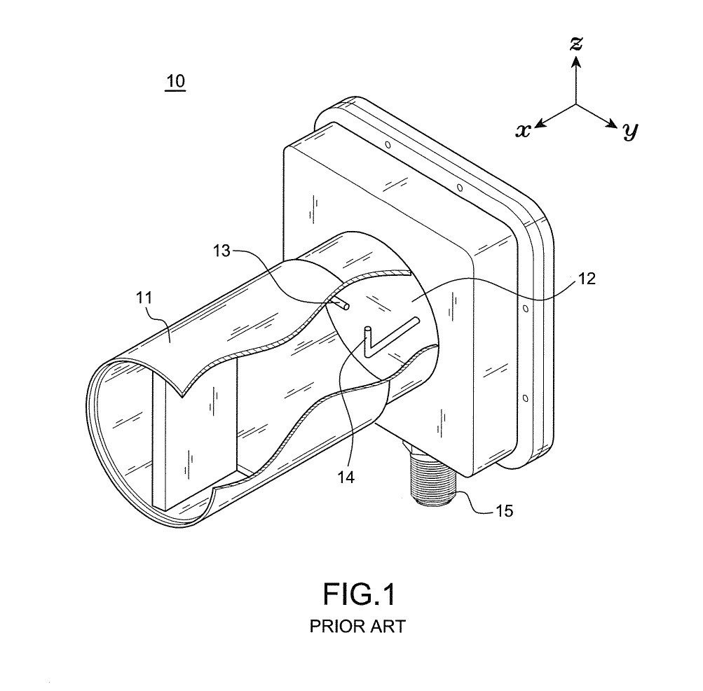

FIG. 2 is an exploded perspective view of the present invention;

FIG. 3 is an exploded perspective view of the present invention, illustrating the printed curcuit board in the front cover;

FIG. 4 is a perspective view illustrating the assembly of FIG. 2;

FIG. 5 is an exploded perspective view of the present invention at another angle;

FIG. 6 is a perspective view illustrating the assembly of FIG. 5;

FIG. 7 is a rear perspective view of FIG. 6;

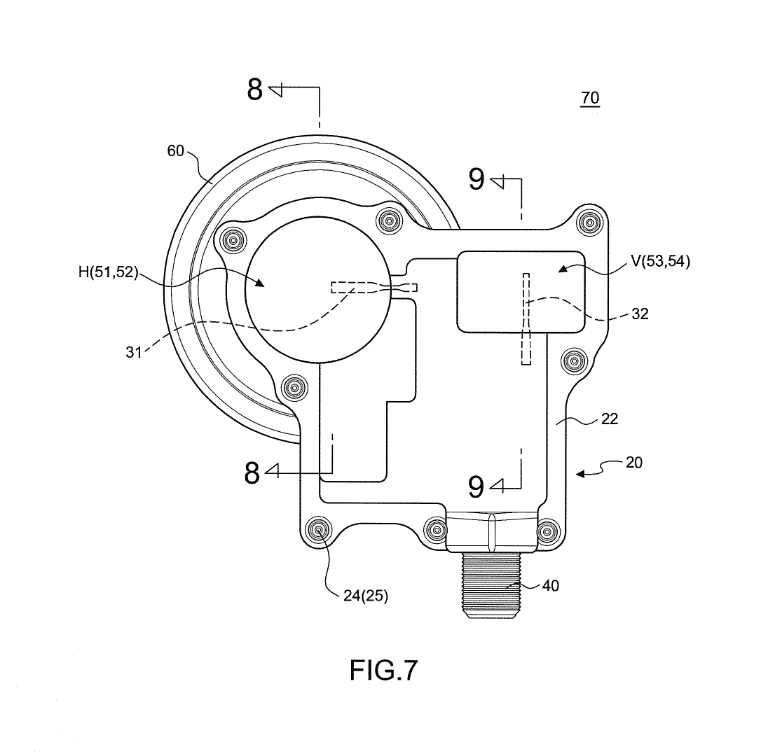

FIG. 8 is a cross-sectional view taken along the line 8-8 in FIG. 7; and

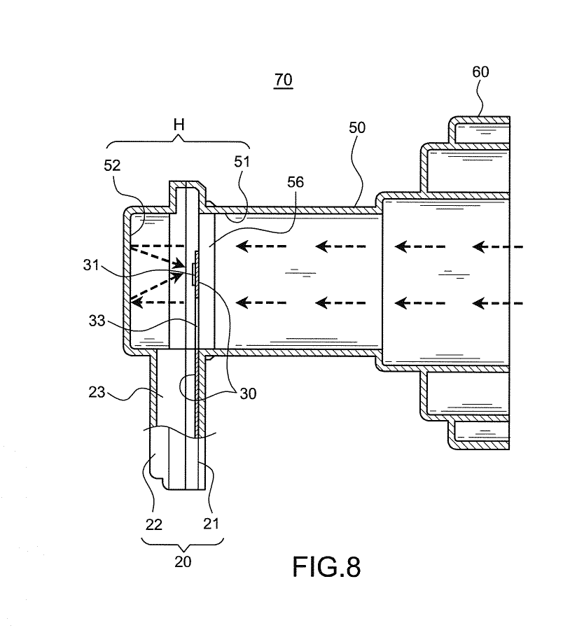

FIG. 9 is a cross-sectional view taken along the line 9-9 in FIG. 7.

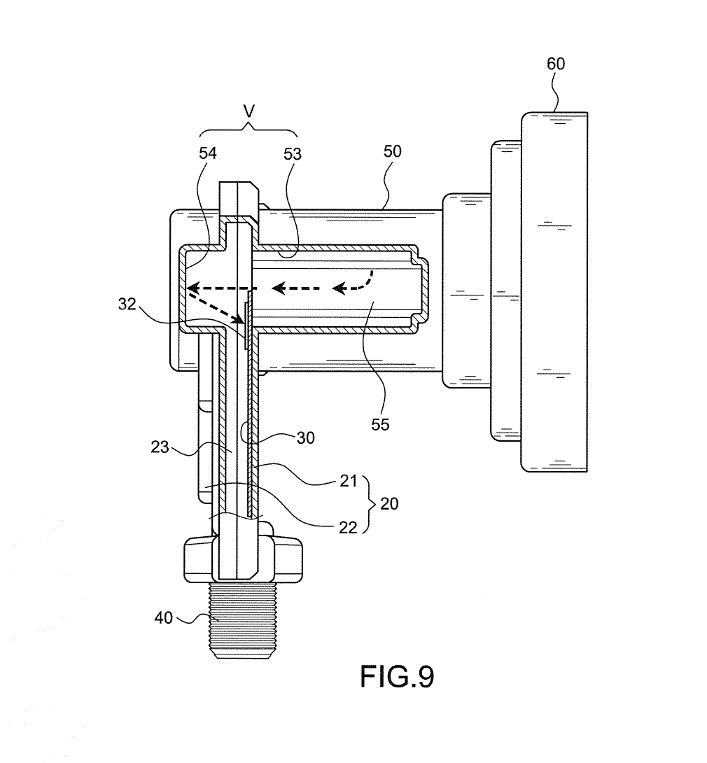

### DETAILED DESCRIPTION OF THE PREFERRED EMBODIMENT

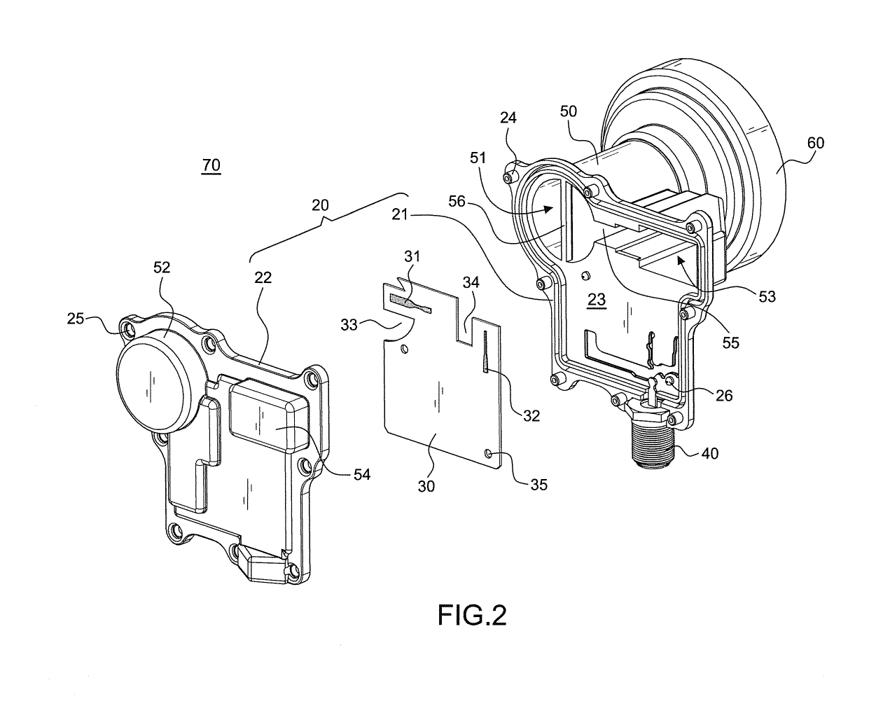

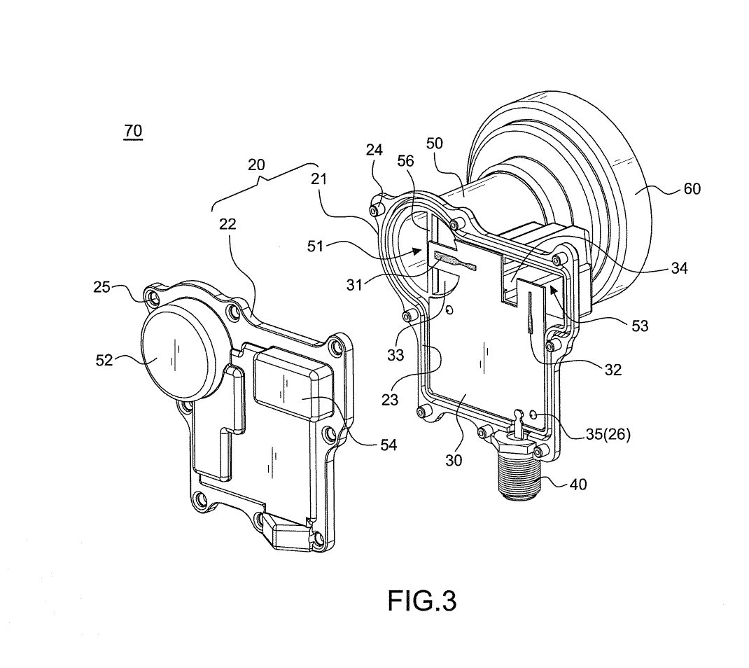

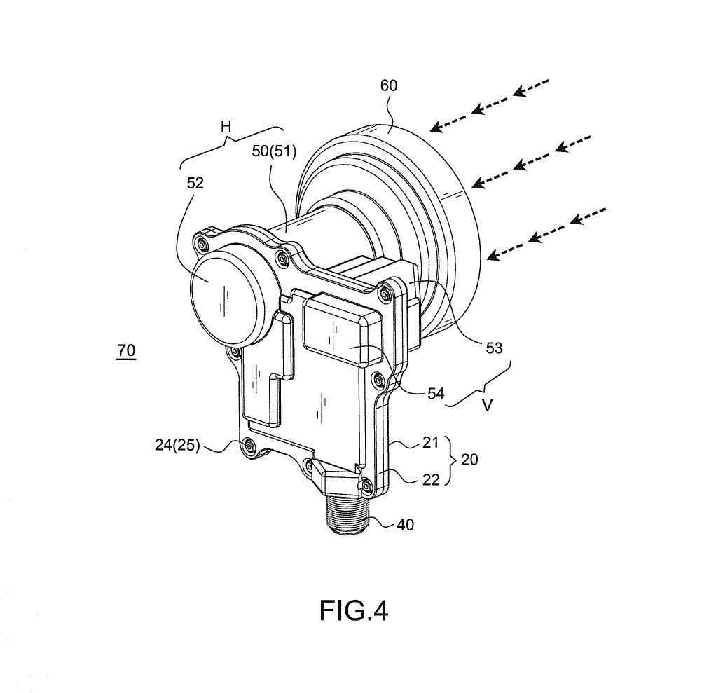

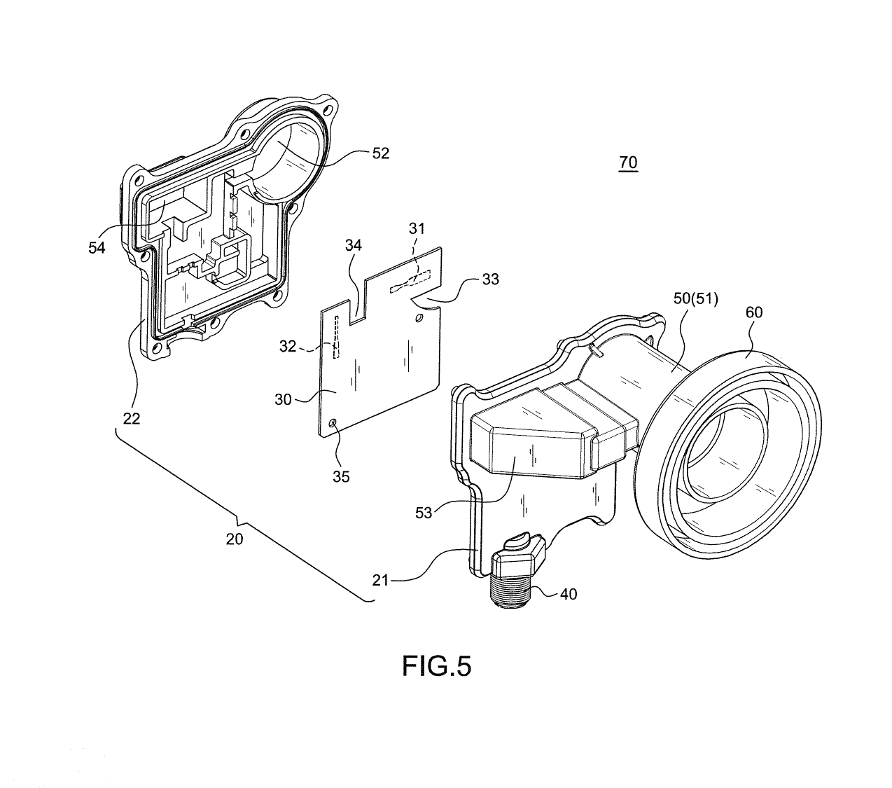

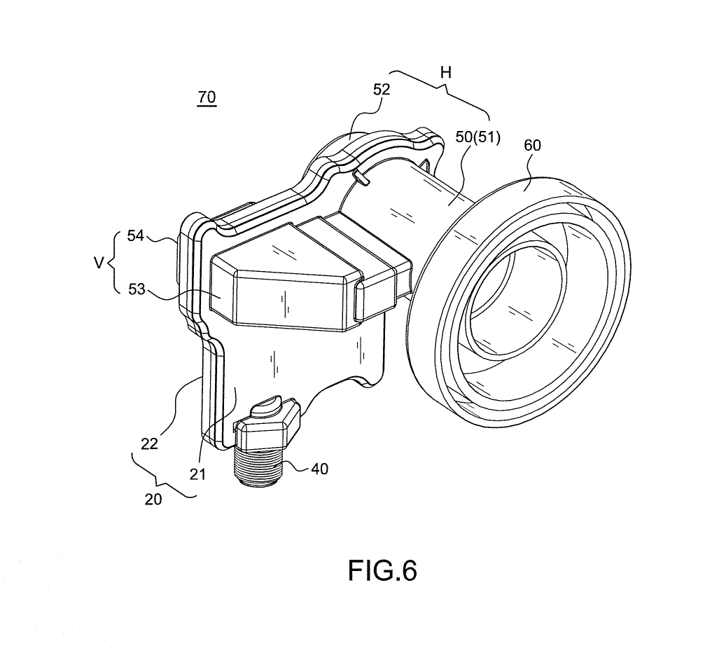

FIGS. 2 to 4 illustrate the forward oblique drawings of the present invention; FIGS. 5 and 6 illustrate the backward oblique drawings of the present invention, and the preferred embodiment of the present invention includes: a body 20 having a recessed accommodation area 23 inside thereof, a printed circuit board 30 having a circuit as a common downconverter needed, being arranged in the recessed accommodation area 23 and being electronically connected to an output terminal 40, a waveguide 50 being a tubular body extending forward from the body 20 to form a first waveguide chamber 51 in the waveguide 50; in this embodiment, a vertical partition is arranged inside the first waveguide chamber 51, but it is not a limitation; and a feedhorn 60 being composed of a serial concentric ring on a front end of the waveguide 50; however, the above-disclosed features belong to prior art and thus will not be described in details here.

The main features of the present invention includes: the body 20 is composed of a front cover 21 and a rear cover 22. In this embodiment, a plurality of association pillars 24 are set on a periphery of the front cover 21, and the rear cover 22 corresponding to the plurality of association pillars 24 of the front cover 21 has a plurality of association holes 25. The association pillars 24 and the association holes 25 are coupled together by a positioning element such as a screw (not shown in FIG.) Further, a forward extended third waveguide chamber 53 is connected with a side of the first waveguide chamber 51 of the waveguide 50. In this embodiment, a long groove 55 is connected between the first waveguide chamber 51 and the third waveguide chamber 53, and the third waveguide chamber 53 is transversely extended from the long groove 55 forming a long cavity with a sealed front side surface, a sealed periphery and a rearward opening facing to the printed circuit board 30.

Further, the rear cover 22 corresponding to the third waveguide chamber 53 has a backward extended fourth waveguide chamber 54, and the fourth waveguide chamber 54 is a long cavity having a seal rear side surface, a seal periphery and a forward opening facing to the printed circuit board 30. Thus, a vertical wave cavity V is formed by the combination of the third waveguide chamber 53 and the fourth waveguide chamber 54.

Further, the rear cover 22 corresponding to the first waveguide chamber 51 has a backward extended second waveguide chamber 52. In this embodiment, the second waveguide chamber 52 corresponding to the first waveguide chamber 51 is a circular cavity with a sealed rear side surface, a sealed periphery and a forward opening facing to the printed circuit board 30. Thus, a horizontal wave cavity H is formed by the combination of the first waveguide chamber 51 and the second waveguide chamber 52.

Further, a rear side of the printed circuit board 30 corresponding to the second waveguide chamber 52 and the fourth waveguide chamber 52 has a horizontal probe 31 and a vertical probe 32 being directly set on the surface thereof. In this embodiment, a notch 33 is arranged around the horizontal probe 31 on the printed circuit board 30 for guiding the horizontal waves from the first waveguide chamber 51 to the second waveguide chamber 52; another notch 34 is arranged around the vertical probe 32 printed circuit board 30 for guiding the vertical waves from the third waveguide chamber 53 to the fourth waveguide chamber 54. The shape of the aforesaid notches 33, 34 is not a limitation as long as they do not interfere with the passing waves. The printed circuit board 30 further comprises a positioning hole 35 for coupling with a positioning pillar 26 in the recessed accommodation area 23 of the front cover 21 in order to fix the printed circuit board 30.

Based on the technical features disclosed, the horizontal probe 31 located between the first waveguide chamber 51 and the second waveguide chamber 52 and facing to the second waveguide chamber 52 for receiving horizontal polarized wave; the vertical probe 32 is located between the third waveguide chamber 53 and the fourth waveguide chamber 54 and facing to the fourth waveguide chamber 54 for receiving vertical polarized wave; thus, a signal of the horizontal wave and a signal of the vertical wave can be separated by a design of the first, second, third, and fourth waveguide chambers 51, 52, 53, 54.

Without the aforesaid separated design of the horizontal wave cavity H and the vertical wave cavity V, the horizontal probe 31 and the vertical probe 32 cannot be directly set on the printed circuit board 30, and the coupling of the probes cannot be reduced. That is, the horizontal wave signal is guided into the horizontal wave cavity H, and the vertical wave signal is guided into the vertical wave cavity V by the design of the present invention while a satellite signal is collected by a dish antenna and fed into a feedhorn 60. Both the horizontal wave cavity H and the vertical wave cavity V are composed of two chambers 51 [symbol] 52, 53 [symbol] 54; thus, the isolation of the horizontal wave and vertical wave is substantially improved.

Base on the features disclosed, the present invention enables the two probes 31, 32 to be positioned on a same plane for substantially reducing the interference of a horizontal and a vertical wave in order to overcome the coupling of a prior art. Therefore, the present invention provides a convenient production and high isolation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A Low Noise Block downconverter (LNB) with high isolation, comprising:
a body having a recessed accommodation area inside thereof;
a printed circuit board being arranged in said recessed accommodation area and being electronically connected to an output terminal;
a waveguide being a tubular body extending forward from said body to form a first waveguide chamber in said waveguide; and
a feedhorn being composed of a serial concentric ring on a front end of said waveguide;
wherein said body is composed of a front cover and a rear cover, a forward extended third waveguide chamber being connected with a side of said first waveguide chamber of said waveguide, said rear cover corresponding to said third waveguide chamber has a backward extended fourth waveguide chamber, said rear cover corresponding to said first waveguide chamber has a backward extended second waveguide chamber; and
a rear side of said printed circuit board corresponding to said second waveguide chamber and said fourth waveguide chamber has a horizontal probe and a vertical probe being directly set on the surface thereof;
whereby said horizontal probe located between said first waveguide chamber and said second waveguide chamber and facing to said second waveguide chamber for receiving horizontal polarized wave, and said vertical probe is located between said third waveguide chamber and said fourth waveguide chamber and facing to said fourth waveguide chamber for receiving vertical polarized wave; thus, a signal of said horizontal wave and a signal of said vertical wave can be separated by a design of said first, second, third, and fourth waveguide chambers.

2. The Low Noise Block downconverter (LNB) with high isolation as claimed in claim 1, wherein said second waveguide chamber is a circular cavity with a sealed rear side, a sealed periphery and a forward opening facing to said printed circuit board so that a horizontal wave cavity is formed by said first waveguide chamber and said second waveguide chamber.

3. The Low Noise Block downconverter (LNB) with high isolation as claimed in claim 2 further comprising a long groove being connected between said first waveguide chamber and said third waveguide chamber, and said third waveguide chamber is transversely extended from said long groove forming a long cavity with a sealed front side, a sealed periphery and a rearward opening facing to said printed circuit board; said fourth waveguide chamber corresponding to said third waveguide chamber has a long cavity with a sealed rear side, a sealed periphery and a forward opening facing to said printed circuit board; thus, a vertical wave cavity is formed by said third waveguide chamber and said fourth waveguide chamber.

4. The Low Noise Block downconverter (LNB) with high isolation as claimed in claim 3 further comprising a notch being set around said horizontal probe on said printed circuit board for guiding said horizontal wave from said first waveguide chamber to said second waveguide chamber, and another notch is set around said vertical probe on said printed circuit board for guiding said vertical wave from said third waveguide chamber to said fourth waveguide chamber.
